(19) United States
(12) Patent Application Publication
(10) Pub. No.: US 2025/0378701 A1
(43) Pub. Date: Dec. 11, 2025

(54) METHOD, SYSTEM, AND COMPUTER PROGRAM PRODUCT FOR PROCESSING MEDICAL IMAGE

(71) Applicant: Seigo NISHIDA, Croton on Hudson, NY (US)

(72) Inventor: Seigo NISHIDA, Croton on Hudson, NY (US)

(21) Appl. No.: 18/734,383

(22) Filed: Jun. 5, 2024

(51) Int. Cl. G06V 20/69; G06V 10/26; G06V 10/40; G06V 10/764; G06V 10/77; G06V 20/50

(52) U.S. Cl. CPC G06V 20/698; G06V 10/26; G06V 10/40; G06V 10/764; G06V 10/77; G06V 20/50; G06V 20/695; G06V 2201/031

(57) ABSTRACT

The present disclosure relates to a method for processing a medical image performed by a processor. The method comprises: obtaining a medical image showing an organ; extracting, from the medical image, at least one target partial image containing an area occupied by the organ with a ratio equal to or greater than a predetermined ratio with respect to a total area of the at least one target partial image; identifying, in the at least one target partial image, at least one target tissue having a region satisfying a predetermined visual condition; calculating a feature quantity of the at least one target tissue; and outputting a processing result including the at least one target partial image and the feature quantity of the at least one target tissue.

### TECHNICAL FIELD

The present disclosure relates to a method, a system, and a computer program product for processing a medical image.

### BACKGROUND

Conventionally, technology for processing medical images of an organ has been developed that can be used in supporting an evaluation of the organ. For example, US 2022/0230310 A1 discloses a system for segmenting around an object of interest in a medical image using a deep learning network.

### SUMMARY

However, there is still a demand for further improvement in the evaluation accuracy. Especially in time-sensitive situations like organ transplantation, evaluations need to be conducted more quickly and accurately. The inventor has also recognized an issue that even a single medical image may yield different evaluation results depending on the skill or subjectivity of the person evaluating it.

Therefore, an object of the present disclosure is to provide a method, a system, and a computer program product for processing a medical image that can improve the accuracy of organ evaluation using a medical image.

To achieve the object, one aspect of the present disclosure is a method for processing a medical image performed by a processor, the method comprising:
obtaining a medical image showing an organ;
extracting, from the medical image, at least one target partial image containing an area occupied by the organ with a ratio equal to or greater than a predetermined ratio with respect to a total area of the at least one target partial image;
identifying, in the at least one target partial image, at least one target tissue having a region satisfying a predetermined visual condition;
calculating a feature quantity of the at least one target tissue; and
   outputting a processing result including the at least one target partial image and the feature quantity of the at least one target tissue.

According to the above-mentioned method, characteristics of an organ shown in a medical image can be provided as objective numerical information. Thereby, the organ evaluation using a medical image can be performed more efficiently, and the fluctuation in evaluation results caused by the skill or subjectivity of evaluators can be minimized. Therefore, the method according to one aspect of the present disclosure can improve the accuracy of organ evaluation using a medical image.

As used herein, the term “organ” generally means a human organ. More preferably, the organ means a human organ to be subjected to organ transplantation. The organ is, for example, a liver, but is not limited thereto and may be any organ, such as a heart, a lung, a kidney, a pancreas, a small intestine, and an eyeball. Furthermore, the organ is not limited to a human organ, but may be an organ of an animal other than a human.

As used herein, the term “medical image” generally means an image showing at least a part of an organ. The image is, for example, a two-dimensional color image, but is not limited thereto and may be any image such as a three-dimensional image or a grayscale image. Moreover, the image may be a still image or a moving image. For example, medical images may include an image showing a biological tissue specimen collected from an organ photographed by an imaging device such as an optical electron microscope. The biological tissue may be stained, before imaging, using techniques, such as hematoxylin and eosin staining (H&M staining), picrosirius red staining (PSR staining), Immunohistochemistry staining (IHC), or trichrome staining. The medical image may include an image of an organ captured by techniques, such as Computed Tomography (CT), Magnetic Resonance Imaging (MRI).

As used herein, the term “visual condition” generally means a condition that can be visually identified from an image. For example, the visual condition may pertain to the contour shape, color, or area of the target tissue.

As used herein, the term “target tissue” means a tissue to be examined among biological tissues included in an organ. The target tissue can be, for example, a fat or a cell nucleus, but is not limited to these and may be any biological tissue contained in an organ, such as a cell, a cancer cell, a hepatocyte, or a collagen.

As used herein, the term “feature quantity” means a quantified characteristic of a target tissue. For example, the quantified characteristic may include, but is not limited to, area, number, color, brightness, contour shape complexity, or dispersion of a target tissue. Methods of quantifying the characteristic may include, but are not limited to, sum, average, standard deviation, variance, proportion, median, minimum value, or maximum value.

As used herein, the term “processing result” means information generated by a processor performing the preceding method for processing a medical image. For example, the processing result may include, but is not limited to, a target partial image extracted from the medical image and a feature quantity of a target tissue shown in the target partial image.

In the preceding method, the medical image is preferably an image of a specimen collected from the organ.

In the preceding methods, the extracting the at least one target partial image preferably comprises:
dividing the medical image into a plurality of partial images having a predetermined image size; and
extracting, as the at least one target partial image, at least one partial image containing an area occupied by the organ with a ratio equal to or greater than the predetermined ratio with respect to a total area of the at least one partial image, from among the plurality of partial images.

In the preceding methods, the identifying the at least one target tissue preferably further comprises identifying, in the at least one target partial image, at least one exclusion region. That is, the at least one exclusion region is identified, in the at least one target partial image, in addition to the at least one target tissue.

In the preceding methods, the predetermined visual condition preferably comprises a condition regarding at least one of the contour shape, color, or area of the at least one target tissue.

The preceding methods preferably further comprise building, by machine learning, a calculation model for identifying the region satisfying the predetermined visual condition.

In the preceding methods, the feature quantity of the at least one target tissue preferably comprises numerical information regarding the area of the at least one target tissue shown in the at least one target partial image.

In the preceding methods, the calculating the feature quantity of the at least one target tissue preferably comprises:
categorizing the at least one target tissue into at least one first target tissue having an area equal to or greater than a predetermined area or at least one second target tissue having an area less than the predetermined area; and
calculating a feature quantity of the at least one first target tissue and a feature quantity of the at least one second target tissue, and
the predetermined area preferably has a size to be identified by human visual observation with a predetermined accuracy.

In the preceding methods, the processing result preferably comprises the at least one target partial image in which the at least one target tissue is highlighted according to the feature quantity.

As used herein, the term “highlighting (a target tissue)” means emphasizing and displaying at least a part of a target tissue in an image. Highlighting may include, but is not limited to, changing color or brightness, or adding contours, hatches, or patterns.

In the preceding methods, identifying the at least one target tissue preferably comprises identifying, in the at least one target partial image, at least one reference tissue, and
calculating the feature quantity of the at least one target tissue preferably comprises:
determining the predetermined categorization condition based on the at least one reference tissue;
categorizing the at least one target tissue into at least one first target tissue satisfying the predetermined categorization condition or at least one second target tissue not satisfying the predetermined categorization condition; and
calculating a feature quantity of the at least one first target tissue and a feature quantity of the at least one second target tissue.

As used herein, the term “reference tissue” means a tissue that is used as a standard for categorizing a target tissue among biological tissues included in an organ. The reference tissue is, for example, a fat or a cell nucleus. The reference tissue may be one of the target tissues. That is, a certain target tissue may be used as a reference tissue for categorizing another target tissue.

In the preceding methods, the predetermined categorization condition is preferably determined based on an area of the at least one reference tissue.

In the preceding methods, the at least one target tissue is preferably a fat and the at least one reference tissue is preferably a cell nucleus.

In the preceding methods, the predetermined categorization condition is preferably determined based on a distance between the at least one target tissue and the at least one reference tissue.

In the preceding methods, the at least one target tissue is preferably a cell nucleus and the at least one reference tissue is a fat.

In the preceding methods, the feature quantity of the at least one target tissue preferably comprises numerical information regarding an area of the at least one first target tissue shown in the at least one target partial image.

In the preceding methods, the feature quantity of the at least one target tissue preferably comprises numerical information regarding a number of the at least one first target tissue shown in the at least one target partial image.

In the preceding methods, the processing result preferably comprises the at least one target partial image in which the at least one first target tissue and the at least one second target tissue are distinctly highlighted.

The preceding methods preferably further comprise accepting user input for changing the predetermined categorization condition.

Another aspect of the present disclosure is a system for processing a medical image comprising:
a processor; and
a memory storing a program which, when executed on the processor, causes the processor to perform operations, the operations comprising:
obtaining a medical image showing an organ;
extracting, from the medical image, at least one target partial image containing an area occupied by the organ with a ratio equal to or greater than a predetermined ratio with respect to a total area of the at least one target partial image;
identifying, in the at least one target partial image, at least one target tissue having a region satisfying a predetermined visual condition;
calculating a feature quantity of the at least one target tissue; and
outputting a processing result including the at least one target partial image and the feature quantity of the at least one target tissue.

Another aspect of the present disclosure is a computer program product for processing a medical image, the computer program product comprising:
a non-transitory computer-readable medium storing a program which, when executed on a processor, causes the processor to execute operations, the operations comprising:
obtaining a medical image showing an organ;
extracting, from the medical image, at least one target partial image containing an area occupied by the organ with a ratio equal to or greater than a predetermined ratio with respect to a total area of the at least one target partial image;
identifying, in the at least one target partial image, at least one target tissue having a region satisfying a predetermined visual condition;
calculating a feature quantity of the at least one target tissue; and
outputting a processing result including the at least one target partial image and the feature quantity of the at least one target tissue.

Accordingly, the present disclosure can provide a method, a system, and a computer program product for processing a medical image that can improve the accuracy of organ evaluation using a medical image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Various objects, features, and accompanying advantages of the present disclosure beyond those listed above will be fully appreciated when considered in conjunction with the accompanying drawings in which:

FIG. 1 is a block diagram showing a schematic configuration of a medical image processing system according to an embodiment of the present disclosure;

FIG. 2 is a block diagram showing a schematic configuration of the processing server shown in FIG. 1;

FIG. 3 is a flowchart showing an operational example of the processing server shown in FIG. 1;

FIG. 4 is a flowchart showing another operational example of the processing server shown in FIG. 1;

FIG. 5 is a schematic diagram of a target partial image;

FIG. 6 is another schematic diagram of a target partial image; and

FIG. 7 is an example of a user interface displayed on the user device by the processing server shown in FIG. 1.

### DETAILED DESCRIPTION

A medical image processing system according to an embodiment of the present disclosure will be described below with reference to the accompanying drawings. In the following description of the present embodiment, the description of the same or corresponding parts will be omitted or simplified as appropriate. In each drawing, the same reference characters designate the same or corresponding parts.

### (Configuration of Medical Image Processing System)

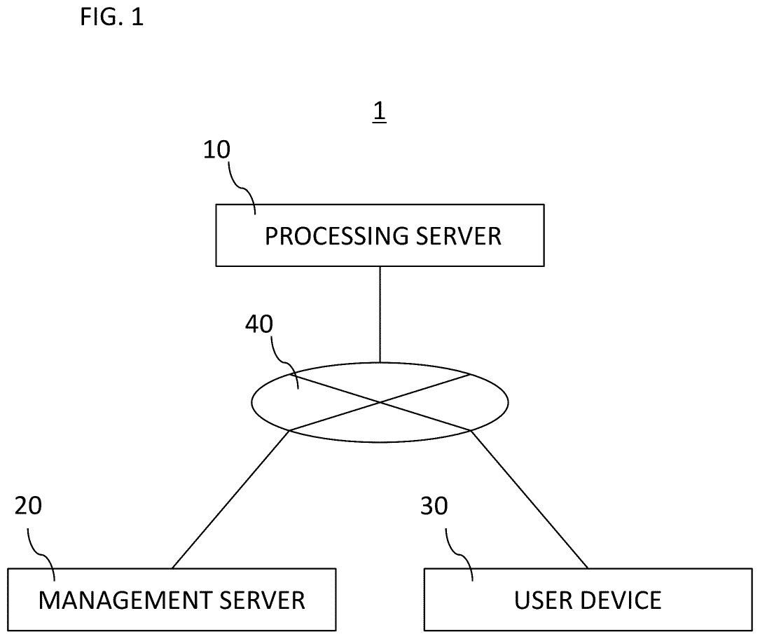

With reference to FIG. 1, an overview of a medical image processing system 1 according to an embodiment of the present disclosure will be described. FIG. 1 is a block diagram showing a schematic configuration of the medical image processing system 1. As illustrated in FIG. 1, the medical image processing system 1 includes a processing server 10, a management server 20, and a user device 30. In the medical image processing system 1, the processing server 10, the management server 20, and the user device 30 are connected to each other via a network 40 so as to be able to communicate with each other. In FIG. 1, the number of processing server 10, management server 20, and user device 30 illustrated therein is one each, for ease of understanding. However, the medical image processing system 1 may include any number of processing servers 10, management servers 20, and user devices 30, respectively. Hereinafter, the medical image processing system 1 is also simply referred to as “system 1.”

The processing server 10 is configured by one or more computers. In the present embodiment, the processing server 10 may be configured by one computer. However, the processing server 10 may be configured by a plurality of computers, such as a cloud computing system. In the system 1, a processing server 10 is configured to process medical images.

The management server 20 is configured by one or more computers. In the present embodiment, the management server 20 may be configured by one computer. However, the management server 20 may be configured by a plurality of computers, such as a cloud computing system. In the system 1, the management server 20 is configured to manage information regarding medical images. For example, the management server 20 may manage information on organs to be subjected to organ transplantation, as well as information on donors and recipients thereof. In such a case, the medical image is an image showing a donor's organ. The management server 20 may also manage electronic medical records in a hospital. In such a case, the medical image is an image of a patient's organ.

The information regarding a medical image may include any information regarding an organ shown in the medical image. For example, the information regarding a medical image may include information such as the donor's and/or patient's identifier (ID), name, gender, age, medical history, organ type, capture date and time of the image, and location information of the organ.

The user device 30 is a computer, such as, but is not limited to, a smartphone, a tablet, or a personal computer. In the present embodiment, the user of the system 1 may be a doctor, such as a pathologist, but is not limited thereto.

The network 40 is a communication network that allows the processing server 10, the management server 20, and the user device 30 to communicate with each other. It may include the Internet, a mobile communication network, a LAN (Local Area Network), or a combination thereof.

The medical image processing system 1 is used for evaluating organs using medical images. For instance, it might quantify of fat in a liver, but is not limited thereto. In the medical image processing system 1, the processing server 10 obtains a medical image showing an organ. For example, the medical image might be uploaded from the user device 30 to the processing server 10 by a user of the system 1 operating the user device 30. The processing server extracts, from the medical image, at least one target partial image containing an area occupied by the organ with a ratio equal to or greater than a predetermined ratio with respect to a total area of the at least one target partial image. Thereafter, the processing server 10 identifies, in at least one target partial image, at least one target tissue having a region satisfying a predetermined visual condition, and then calculates a feature quantity of the at least one target tissue. The processing server 10 outputs a processing result including at least one target partial image and the feature quantity of the at least one target tissue. For example, the processing result may be transmitted from the processing server 10 to the user device 30 and displayed on the user device 30.

Accordingly, the system 1 can provide characteristics of an organ shown in a medical image as objective numerical information. Thus, the system 1 can carry out organ evaluation using a medical image more efficiently, while reducing the fluctuation in evaluation results due to the skill or subjectivity of evaluators. Therefore, the system 1 can improve the accuracy of organ evaluation using a medical image.

### (Configuration of Processing Server)

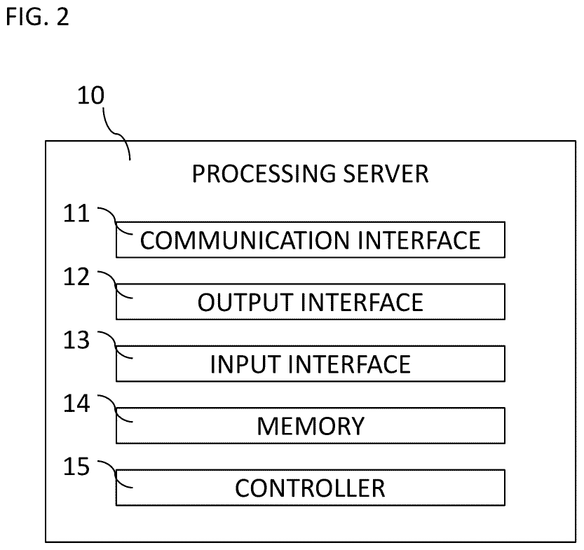

Next, with reference to FIG. 2, a configuration of the processing server is explained in detail. FIG. 2 is a block diagram showing a schematic configuration of the processing server 10 shown in FIG. 1. As illustrated in FIG. 2, the processing server 10 comprises a communication interface 11, an output interface 12, an input interface 13, a memory 14, and a controller 15. The communication interface 11, the output interface 12, the input interface 13, the memory 14, and the controller 15 are communicably connected to each other in a wired or wireless manner.

The communication interface 11 includes a communication module for connecting to the network 40. The communication module is, for example, a communication module compliant with a mobile communication standard such as the 4th Generation (4G) standard or the 5th Generation (5G) standard. The communication module may be, for example, a communication module compliant with a standard such as a wired Local Area Network (LAN) standard or a wireless LAN standard. The communication module may be a communication module compliant with a short-range wireless communication standard such as Wi-Fi, Bluetooth, or an infrared communication standard. In the present embodiment, the processing server 10 is connected to the network via the communication interface 11. This enables the processing server 10 to communicate with the management server 20, the user device 30, another computer, or the like.

The output interface 12 includes at least one output device. The output device included in the output interface 12 is, for example, a display, a speaker, a lamp, or the like. The output interface 12 outputs images, sound, light, or the like.

The input interface 13 includes an input device. The input device included in the input interface 13 is, for example, a touch panel, a camera, a microphone, or the like. The input interface 13 accepts input operations from a user.

The memory 14 is, for example, a semiconductor memory, a magnetic memory, an optical memory, or the like. The memory 14 may function as, for example, a main memory, an auxiliary memory, or a cache memory. The memory 14 stores any information used for operations of the processing server 10. For example, the memory 14 stores a system program, an application program, embedded software, a database, or the like. The information stored in the memory 14 may be updated with, for example, information acquired from the network 40 via the communication interface 11.

The controller 15 includes at least one processor. The processor may be, for example, a general-purpose processor such as a Central Processing Unit (CPU), a dedicated processor that is dedicated to specific processing, or the like. The controller 15 is not limited to including a processor and may include at least one dedicated circuit. Examples of dedicated circuits may include a Field-Programmable Gate Array (FPGA) and an Application Specific Integrated Circuit (ASIC). The controller 15 controls the above-described components, such as the communication interface 11, the output interface 12, the input interface 13, and the memory 14, to realize the functions of the processing server 10, including the functions of these components.

The management server 20 and the user device 30 may, but are not limited to, have the same or similar configuration to the processing server 10. The management server 20 and the user device 30 may respectively comprise a communication interface, an output interface, an input interface, a memory, and a controller, which are described above as components of the processing server 10.

### (Operational Examples of Medical Image Processing System)

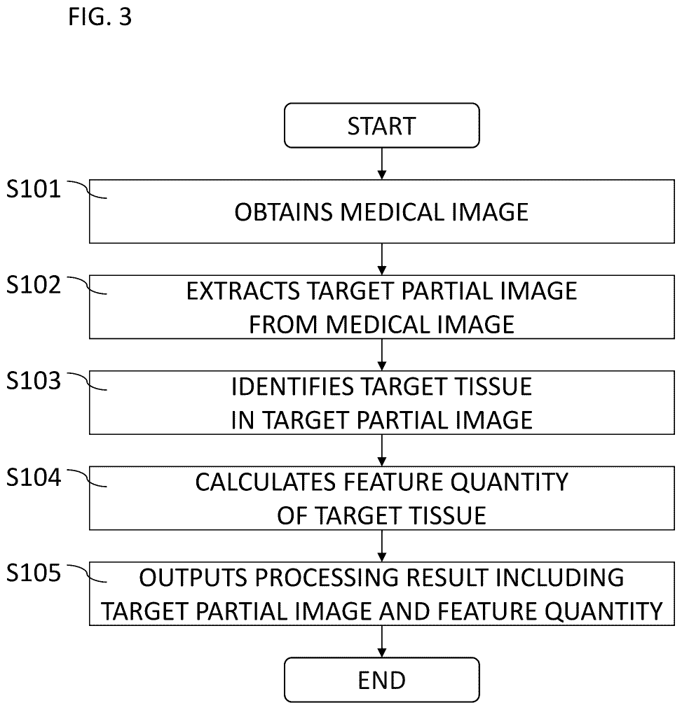

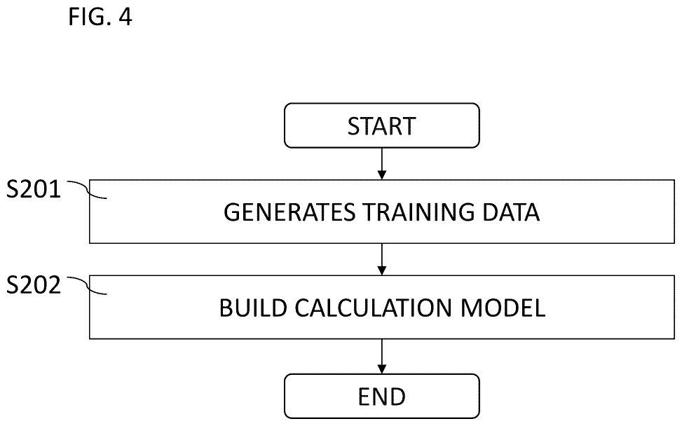

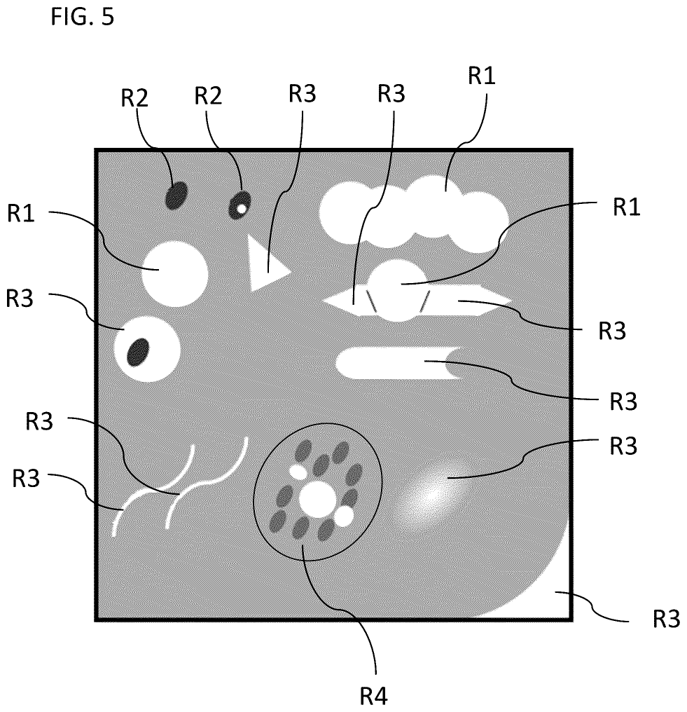

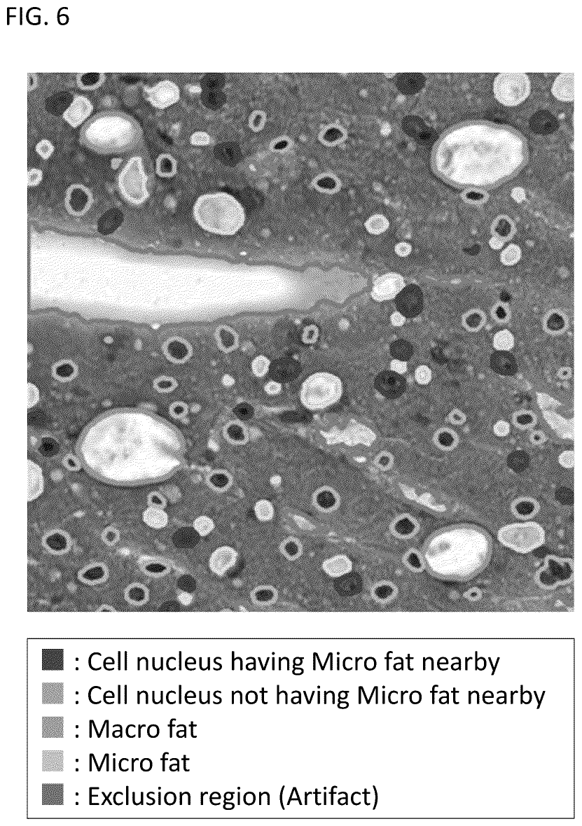

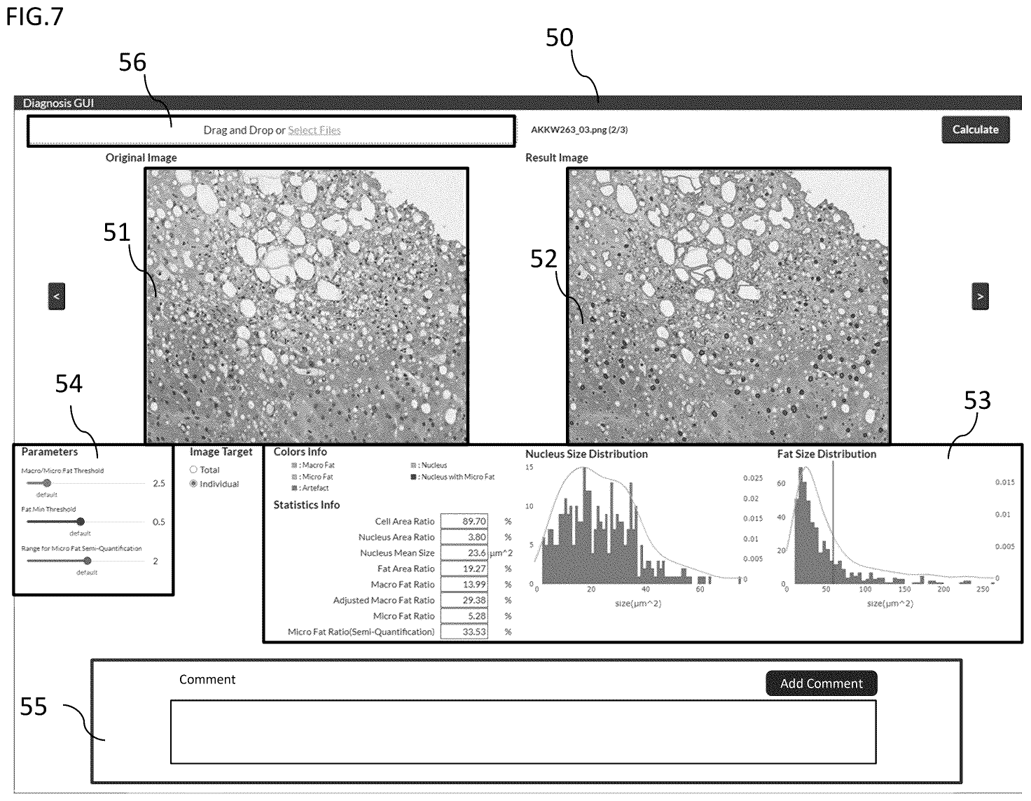

Referring to FIGS. 3, 4, 5, 6, and 7, operations of processing a medical image provided by the medical image processing system 1 is described. FIG. 3 is a flowchart showing an operational example of the processing server 10 shown in the medical image processing system 1. FIG. 4 is a flowchart showing another operational example of the processing server 10. FIG. 5 is a schematic diagram of a target partial image. FIG. 6 is another schematic diagram of a target partial image. FIG. 7 is an example of a user interface displayed on the user device 30 by the processing server 10. The flowcharts shown in FIGS. 3 and 4 illustrate operations of the processing server 10. Therefore, the description of these operations corresponds to both a description of the medical image processing system 1 and a description of a method for processing a medical image performed by a processor included in the processing server 10.

### (Operation of Processing Medical Image)

First, with reference to FIG. 3, the operation of processing a medical image in the medical image processing system 1 is described.

In step S101, the controller 15 of the processing server 10 obtains a medical image showing an organ.

The medical image showing an organ is, for example, an image of a specimen collected from an organ. In the present operation example, the medical image showing an organ is explained as a color image of a biological tissue specimen collected from a liver that has been stained with H&M staining and then photographed using an imaging device such as an optical electron microscope.

For example, the medical image may be uploaded from the user device to the processing server 10 by a user of the system 1 operating the user device 30. The controller 15 of the processing server 10 may communicate with the user device 30 via the communication interface 11 and cause the user device to display a user interface 50 for uploading a medical image. As described in detail later, as shown in FIG. 7, the user interface 50 includes a file upload section 56. The controller 15 of the processing server 10 can obtain a medical image from the user device 30 via the communication interface 11. Alternatively, the management server 20 may store medical images. In such a case, the controller 15 of the processing server 10 can obtain a medical image from the management server 20 via the communication interface 11. The controller 15 may store the obtained medical image in the memory 14 in association with an identifier (ID) uniquely identifying the medical image.

Referring again to FIG. 3, in step S102, the controller 15 of the processing server 10 extracts, from the medical image, at least one target partial image containing an area occupied by an organ with a ratio equal to or greater than a predetermined ratio with respect to a total area of the at least one target partial image.

Any method can be employed for extracting a target partial image. In the present operational example, the controller 15 of the processing server 10 divides a medical image into a plurality of partial images each having a predetermined image size. The predetermined image size is, for example, 1024×1024 pixels. Then, the controller 15 extracts, as a target partial image, a partial image containing an area occupied by an organ with a ratio equal to or greater than the predetermined ratio with respect to the total area of the partial image, from among the plurality of partial images. For example, the controller may perform image analysis on a partial image and determine, as a target partial image, a partial image in which the number of pixels having a color indicating the organ with respect to the total number of pixels in the partial image is equal to or greater than a predetermined ratio. The controller 15 may apply edge detection to a partial image to identify the contour of an organ and determine, as a target partial image, a partial image in which the area occupied by the organ with respect to the total area of the partial image is equal to or greater than a predetermined ratio.

For example, the predetermined ratio may be 80% of the total area of a partial image. In this way, even if medical images of various image sizes are input to the processing server 10, the image size of the target partial images to be subjected to subsequent processing of step S102 is made uniform, and therefore, it is possible to suppress an increase in the amount of calculation processing and processing time of the controller 15 in subsequent processing. In addition, the controller 15 can exclude partial images containing a lot of noise from processing targets by determining, as a target partial image, a partial image containing the predetermined ratio or more of the area occupied by the organ. This further improves the accuracy of evaluating an organ shown in a medical image by the system 1. The controller 15 may extract any number of target partial images from one medical image. The controller 15 may store the extracted at least one target partial image in the memory 14 in association with the medical image identifier.

In step S103, the controller 15 of the processing server 10 identifies, in the at least one target partial image, at least one target tissue having a region satisfying a predetermined visual condition. When a plurality of target partial images is extracted in step S102, the controller 15 may repeat step S103 and subsequent processing for the number of target partial images.

The predetermined visual condition used in step S103 comprises a condition regarding at least one of the contour shape, color, or area of the at least one target tissue. The predetermined visual condition may be determined depending on the target tissue.

In the present embodiment, the target tissue may be fat or a cell nucleus. As shown in FIG. 5, when the target tissue is fat, the region R1 that satisfies the predetermined visual condition may be a white region with a rounded contour, a region where white regions with a rounded contour to be connected, or a white region with a partially rounded contour that is at least partially included in a region determined to be an artifact.

When the target tissue is a cell nucleus, the region R2 that satisfies the predetermined visual condition may be a dark oval region.

Any method can be employed for identifying a target tissue. The controller 15 of the processing server 10 may store in advance in the memory 14 an image analysis algorithm for identifying a region R1 or R2 that satisfies the predetermined visual condition. The controller 15 can use an image analysis algorithm to identify a region that satisfies the predetermined visual condition as a target tissue.

In the present embodiment, the image analysis algorithm applied to identify a target tissue includes one or more calculation models built using machine learning. Machine learning is a technology in which computers learn rules or patterns based on vast amounts of data. Machine learning includes, for example, support vector machines, decision trees, random forests, neural networks, and deep learning. If there are multiple types of target tissues to be identified, a different calculation model may be prepared for identifying each target tissue, or a single calculation model may be prepared for identifying the multiple target tissues. Here, the calculation model receives a target partial image as input, and then specifies a region within the target partial image that satisfies a predetermined visual condition as a target tissue. The controller 15 of the processing server 10 may store the identified target tissue in the target partial image in the memory 14 in association with the identifier of the medical image. By using a calculation model, the controller 15 can improve the accuracy of identifying a target tissue through training of the calculation model. However, in addition to/in place of a calculation model, the image analysis algorithm may include a calculation formula that is not based on machine learning.

In identifying at least one target tissue in step S103, the controller 15 of the processing server 10 may identify elements other than the target tissue in the at least one target partial image, together with the target tissue.

Elements other than a target tissue include, for example, a reference tissue that is used as a standard for categorizing the target tissue in subsequent processing. In the present embodiment, the reference tissue is explained as being selected from target tissues. That is, one of target tissues is used as a reference tissue for categorizing other target tissues. However, a tissue other than the target tissues may be identified as a reference tissue.

Further, the element other than a target tissue may include, for example, an exclusion region. The excluded region includes an artifact. The artifact may be a noise that occurs within an image during generating the image. As shown in FIG. 5, the region R3 satisfying the visual condition for an artifact may be a region, such as a long and narrow white region, a white region with a cut in the contour of the region, a white region with an unrounded contour, a distorted white region with a blurred contour, a white region containing a cell nucleus, a thin white streak, and a region with unstable colors located at the edge of a target image. In addition to an artifact, the exclusion region may include a region R4 showing a tissue other than a target tissue or a reference tissue, such as a portal triad or a collagen within a liver.

Similarly to identifying a target tissue, an image analysis algorithm including a calculation model build by machine learning may be applied to identify an element other than the target tissue. By actively identifying an element other than a target tissue, the accuracy of identifying the target tissue can be further improved. The controller 15 of the processing server 10 may store, in the memory 14, the identified element other than the target tissue in the target partial image, in association with the identifier of the medical image.

Referring again to FIG. 3, in step S104, the controller 15 of the processing server 10 calculates a feature quantity of at least one target tissue.

The feature quantity of the target tissue may include any numerical information. For example, the feature quantity of the target tissue comprises numerical information regarding an area of a target tissue. The numerical information regarding an area may be an area of each target tissue, the total area or average area of target tissues, or the like. For example, a numerical information regarding an area may be a ratio of the total area of a target tissue with respect to the total area of an organ shown in a target partial image. In the present operation example, a Fat Area Ratio and a Cell Nucleus Region Ratio are calculated as feature quantities of the target tissue.

Fat Area Ratio is a ratio of the total area of fats with respect to the total area of a liver shown in a target partial image. Fat Area Ratio is expressed by the following formula (1).

$$Fat Area Ratio = \frac{{S}_{fat}}{{S}_{all} - {S}_{exclusion}} \qquad ( 1 )$$

Here, Sₐₗₗ is the total area of an image, S_{exclusion} is the total area of exclusion regions in the image, and S_{fat} is the total area of fats in the image.

Cell Nucleus Area Ratio is a ratio of the total area of cell nuclei with respect to the total area of a liver shown in a target partial image. Cell Nucleus Area Ratio is expressed by the following formula (2).

$$Cell Nucleus Area Ratio = \frac{{S}_{Nucleus}}{{S}_{all} - {S}_{exclusion}} \qquad ( 2 )$$

Here, Sₐₗₗ is the total area of an image, S_{exclusion} is the total area of exclusion regions in the image, and S_{nucleus} is the total area of cell nuclei in the image.

For example, the feature quantity of the target tissue may be the number of target tissues shown in a target partial image. The controller 15 of the processing server 10 may store the calculated feature quantity of the target tissue in the memory 14 in association with the identifier of the medical image.

In calculating a feature quantity of a target tissue in step S104, the controller 15 of the processing server 10 may categorize target tissues into a plurality of groups based on a predetermined categorization condition. For example, the controller 15 may categorize target tissues into a first target tissue satisfying the predetermined categorization condition or a second target tissue not satisfying the predetermined categorization condition.

Any method can be employed for categorizing target tissues. For example, the predetermined categorization condition may be a condition that allows a target tissue to be identified by human visual observation with a predetermined accuracy. For example, the predetermined categorization condition is a condition that a target tissue has an area equal to or greater than a predetermined area. In this case, the predetermined area has a size to be identified by human visual observation with a predetermined accuracy, determined based on past research results.

For example, as shown in FIG. 6, a liver contains fat of various sizes. When the target tissue is a tissue that has a wide range of areas shown in an image, such as a fat, the larger the target tissue is, the higher the accuracy of identify a target tissue by human visual observation becomes. On the other hand, the smaller the target tissue is, the lower the accuracy of identify the target tissue by human visual observation becomes. Accordingly, as a target tissue becomes smaller, the difference between the feature quantity of the target tissue calculated based on human visual observation and the feature quantity calculated based on image processing becomes larger. As a result, even if the feature quantity of the target tissue calculated by the system 1 is output as it is, a user of the system 1 may have lower confidence in the feature quantity calculated by the system 1.

Therefore, the controller 15 of the processing server 10 may categorize target tissues into a first target tissue having an area equal to or greater than a predetermined area, or a second target tissue having an area less than the predetermined area. Then, the controller 15 may calculate the feature quantity of the first target tissue and the feature quantity of the second target tissue, in addition to the feature quantity of the entire target tissue. This enables the controller 15 to calculate the feature quantity of the first target tissue as a feature quantity close to the result of human visual observation. That is, the controller 15 may calculate the feature quantities for two groups of the target tissues respectively: one group of target issues where the feature quantities calculated by the system and by human visual observation are similar; and another group that consists of the remaining target tissues not included in the first group, in addition to calculating the feature quantity of the entire target tissues. As such, the controller 15 can improve the user's confidence in the feature quantity calculated by the system 1. The controller 15 may store the calculated feature quantity of the target tissue in the memory 14 in association with the identifier of the medical image.

In categorizing target tissues, the controller 15 of the processing server may categorize target tissues shown in a medical image using the predetermined categorization condition determined based on a reference tissue shown in the medical image.

Specifically, the controller 15 of the processing server 10 identifies a reference tissue in a target partial image in the processing of step S102. The controller 15 utilizes the identified reference tissue to determine a predetermined categorization condition for categorizing the target tissues shown in the target partial image. The predetermined categorization condition may be a condition that the target tissues are identified by human visual observation with a predetermined accuracy. The controller 15 then categorizes the target tissue into a first target tissue satisfying the predetermined categorization condition or a second target tissue not satisfying the predetermined categorization condition. The controller 15 calculates the feature quantities of the first target tissue and the second target tissue, in addition to/in place of the feature quantity of the entire target tissue. Accordingly, even if medical images with various resolutions are input to the processing server 10, it is possible to reduce fluctuation in categorization of target tissues for each image by categorizing target tissues shown in an image using another tissue also shown in the image as a reference tissue.

Categorization of target tissues using a reference tissue is explained below by giving a specific example. In the present operational example, each of a fat and a cell nucleus respectively identified as a target tissue is used as a reference tissue for each other. That is, the controller 15 of the processing server 10 may use, in order to categorize fats, the predetermined categorization condition defined using a cell nucleus as a reference tissue. Further, the controller 15 may use, in order to categorize cell nuclei, the predetermined categorization condition defined using a fat as a reference tissue.

As a first example, it is explained a case where the target tissue is a fat, and the reference tissue is a cell nucleus. In the first example, the fats are categorized using the cell nucleus as the reference tissue. In the first example, the predetermined categorization condition is determined based on the area of at least one reference tissue. Specifically, the predetermined categorization condition may be a condition that the area of a fat as the target tissue is five times or more greater than the average area of cell nuclei as the reference tissue. The predetermined categorization condition may be set to be an area condition that allows the target tissue to be identified by human visual observation with a predetermined accuracy, based on past research results. In the present operation example, the controller 15 of the processing server 10 categorizes fats shown in the target partial image into a macro fat, which is equal to or greater than a predetermined area based on the cell nucleus, and a micro fat, which is smaller than the predetermined area. Then, the controller 15 calculates Macro Fat Area Ratio and Micro Fat Area Ratio, as feature quantities of the target tissue.

Macro Fat Area Ratio is a ratio of the total area of macro fat with respect to the total area of a liver shown in a target partial image. Macro Fat Area Ratio is expressed by the following formula (3).

$$Macro Fat Area Ratio = A \times \frac{{S}_{macro}}{{S}_{all} - {S}_{exclusion}} \qquad ( 3 )$$

Here, Sₐₗₗ is the total area of an image, S_{exclusion} is the total area of exclusion regions in the image, S_{macro} is the total area of macros fat in the image, and A is a correction coefficient.

Micro Fat Area Ratio is a ratio of the total area of micro fat with respect to the total area of a liver shown in a target partial image. Micro Fat Area Ratio is expressed by the following formula (4).

$$Micro Fat Area Ratio = B \times \frac{{S}_{micro}}{{S}_{all} - {S}_{exclusion}} \qquad ( 4 )$$

Here, Sₐₗₗ is the total area of an image, S_{exclusion} is the total area of exclusion regions in the image, S_{micro} is the total area of micro fats in the image, and B is a correction coefficient.

As described above, target tissues shown in a target partial image may be categorized into a first target tissue and a second target tissue, or the feature quantity of the target tissue may comprise at least one of the numerical information regarding an area of the first target tissue and the numerical information regarding an area of the second target tissue. This enables the system 1 to output the feature quantity of the entire target tissue along with the feature quantity of the partial group of the target issues where the feature quantities calculated by the system and by human visual observation are similar. Accordingly, the user's confidence in the feature quantity calculated by the system 1 can be improved.

As a second example, it is explained a case where the target tissue is a cell nucleus, and the reference tissue is a fat. In the second example, the cell nucleus is categorized using a fat as the reference tissue. In the second example, the predetermined categorization condition is determined based on the distance between at least one target tissue and at least one reference tissue. Specifically, the predetermined categorization condition is determined based on the distance between the center of gravity of a target tissue and the center of gravity of a reference tissue closest to the target tissue. The predetermined categorization condition may be set to be a distance condition that the target tissue and the reference tissue are close enough to be considered part of the same tissue element, based on past research results.

For example, in the present operational example, the tissue element including the target tissue and the reference tissue is a hepatocyte including a cell nucleus and a fat. In a liver, there are hepatocytes containing fat and hepatocytes not containing fat. When the ratio of hepatocytes containing fat with respect to the total hepatocytes contained in a liver increases, the liver may be determined to be unsuitable for organ transplantation. However, it is difficult to distinguish between hepatocytes containing or not containing fat and to accurately calculate their numbers. As a result of extensive studies, the inventor of the present disclosure has found that it is possible to semi-quantitatively assess hepatocytes containing or not containing fat, which were difficult to quantify, by considering a cell nucleus having a fat within a predetermined distance as a hepatocyte containing a fat.

In the present operation example, as shown in FIG. 6, the controller 15 of the processing server 10 categorizes a cell nucleus having a micro fat within a predetermined distance as a hepatocyte containing a fat, while a cell nucleus not having a micro fat within the predetermined distance is categorized as a hepatocyte not containing a fat. Then, the controller 15 calculates a Fat Retention Rate as a feature quantity of the target tissue.

Fat Retention Rate is a ratio of the number of cell nuclei having micro fats nearby with respect to the total number of cell nuclei shown in a target partial image. Fat Retention Rate is expressed by the following formula (5).

$$Fat Retention Rate = \frac{{N}_{nucleus with micro}}{{N}_{nucleus}} \qquad ( 5 )$$

Here, N_{nucleus with micro} is the total number of cell nuclei with micro fat, and N_{nucleus} is the total number of cell nuclei shown in the image. This allows a user of the system 1 to accurately grasp the proportion of hepatocytes containing fat to all hepatocytes shown in a medical image based on the fat retention rate.

As described above, it is possible to categorize target tissues shown in a target partial image into first target tissues satisfying a predetermined categorization condition or second target tissues not satisfying the predetermined categorization condition, and then calculate the feature quantity of the first target tissues in association with a specific characteristic, such as suitability for organ transplantation. The feature quantity of a target tissue may comprise, but is not limited to, numerical information regarding the number of the first target tissue shown in the target partial image. Accordingly, the controller 15 of the processing server 10 may calculate the feature quantities for two groups of the target tissues respectively: one group of target issues associated with a specific characteristic; and another group that consists of the remaining target tissues not included in the first group, in addition to calculating the feature quantity of the entire target tissues. As such, the controller 15 can improve the usefulness of the feature quantity calculated by the system 1.

Referring again to FIG. 3, in step S105, the controller 15 of the processing server 10 outputs a processing result including at least one target partial image and a feature quantity of at least one target tissue shown in the target partial image.

Any method can be employed for outputting a processing result. For example, the controller 15 of the processing server 10 generates a processing result including at least one target partial image and a feature quantity of at least one target tissue shown in the target partial image. The controller 15 may display the processing result via the output unit 12 such as a display. Alternatively, the controller 15 may transmit, via the communication interface 11, a request to display the user interface 50 including the processing result to the user device 30. In such a case, the user device 30 can display the processing result via a display or the like, based on the request received from the processing server 10.

FIG. 7 shows an example of the user interface 50 displayed on the user device 30. As shown in FIG. 7, the user interface 50 includes, as a processing result, an original image section 51, a highlight image section 52, a feature quantity section 53, a slider section 54, a user input section 55, and a file upload section 56.

The original image section 51 is a region that displays an original target partial image before being highlighted. The highlight image section 52 is a region where a highlighted target partial image is displayed. The highlight image section 52 may display a target partial image as shown in FIG. 6. In the highlight image section 52, fats are displayed distinctly as macro fats and micro fats by highlighting their contours in different colors. In addition, in the highlight image section 52, cell nuclei are displayed distinctly as cell nuclei having a fat nearby and cell nuclei not having a fat nearby by highlighting their contours in different colors. As described above, the processing result may comprise at least one target partial image in which at least one target tissue is highlighted according to the feature quantity thereof. More specifically, the processing result may comprise at least one target partial image in which the first target tissues and second target tissues categorized in the process of step S104 are distinctly highlighted. This allows a user of the system 1 to intuitively grasp the characteristics of an organ shown in a medical image.

Referring again to FIG. 7, the feature quantity section 53 is a region that displays the feature quantity calculated by the above-articulated process. In addition to/in place of a numerical value representing the feature quantity, the feature quantity section 53 may include a graph visualizing the feature quantity in a manner such as a histogram. For example, the feature amount area 53 may display Fat Area Ratio of the entire fats and Macro Fat Area Ratio of the macro fats. This enables a user to compare Macro Fat Area Ratio, which is close to the user's own visual recognition, with Fat Area Ratio, which is the feature amount of the fat calculated by the system 1. As a result, users of the system 1 can understand that there is a difference in the accuracy of image processing between humans and machines, and therefore the user's confidence in the processing results presented by the system 1 improves.

Accordingly, the system 1 can provide the characteristics of an organ shown in a medical image as objective numerical information. Thereby, with using the system 1, an organ evaluation using a medical image can be performed more efficiently, and the fluctuation in evaluation results caused by the skill or subjectivity of evaluators can be minimized. Therefore, the system 1 enables improvement in the accuracy of organ evaluation using a medical image.

In outputting a processing result in step S105, the controller 15 of the processing server 10 may accept user input for changing a predetermined categorization condition.

Specifically, the controller 15 of the processing server 10 may accept user input for changing a predetermined categorization condition via the user interface 50 displayed on the display of the user device 30. In FIG. 7, user interface 50 includes a slider section 54 that displays sliders related to predetermined categorization conditions. The accuracy of identifying a target tissue in a medical image by human visual observation varies depending on the user of the system 1. Therefore, each user of the system 1 can change the predetermined categorization conditions using the sliders to display the processing result in a manner similar to how the user recognizes the target tissue through the user's own visual observation. For example, the user can operate the slider to change the threshold for categorizing fats (as target tissues) into macro fats (as first target cells) or micro fats (as second target cells). This helps a user of the system 1 to understand that there is a difference in the accuracy of image processing between humans and machines, and therefore improves user confidence in the processing result presented by the system 1.

The system 1 allows a user of the system 1 to input, via the user input section 55, the user's evaluation based on the displayed target partial image and feature quantity, by operating the user device 30. This way, the controller of the processing server 10 can obtain, via the communication interface 11, the user input such as an evaluation, from the user device 30. The controller may store the user input in the memory 14 in association with the medical image identifier as part of a processing result. Moreover, the controller 15 may transmit, via the communication interface 11, a request to register a processing result including the user input to the management server 20.

### (Operation of Building Calculation Model)

Next, with reference to FIG. 4, the operation of building a calculation model by machine learning in the medical image processing system 1 is explained. As described above, a calculation model may be used to identify a target tissue in step S103. The controller 15 of the processing server 10 may build, by machine learning, a calculation model for identifying a region satisfying a predetermined visual condition.

In step S201, the controller 15 of the processing server 10 generates training data for building a calculation model.

Any method can be employed for generating training data. For example, the controller 15 of the processing server 10 may generate training data including explanatory variables and objective variables respectively corresponding to inputs and outputs of a calculation model. The training data is, for example, a set of a partial image of a medical image and information on a target tissue identified manually within the partial image. This can improve the accuracy of the output from the calculation model, by accumulating the training data. The controller 15 may use images obtained by rotating a single partial image by 90 degrees as different training data. This enables to improve the accuracy of the output from the calculation model, even when the amount of training data is not large. Moreover, the controller 15 may use history data of input operations by a user of the system 1 as training data. For example, the history data of input operations may include slider operations or information input into a user input section 55. This can improve the accuracy of the output from the calculation model using feedback from users regarding the processing results by the system 1.

In step S202, the controller 15 of the processing server 10 build a calculation model based on the teacher data by machine learning. The controller 15 may store the built calculation model in the memory 14.

As described above with reference to the accompanying drawings, in the medical image processing system 1 according to the present disclosure, the processing server 10 obtains a medical image showing an organ, and then extracts, from the medical image, at least one target partial image containing an area occupied by the organ with a ratio equal to or greater than a predetermined ratio with respect to a total area of the at least one target partial image. Thereafter, the processing server 10 identifies, in at least one target partial image, at least one target tissue having a region satisfying a predetermined visual condition, and then calculates a feature quantity of the at least one target tissue. The processing server 10 outputs a processing result including at least one target partial image and the feature quantity of the at least one target tissue.

According to the above-mentioned configuration, the system 1 can provide characteristics of an organ shown in a medical image as objective numerical information. Thus, the system 1 can carry out organ evaluation using a medical image more efficiently, while reducing the fluctuation in evaluation results due to the skill or subjectivity of evaluators. Therefore, the system 1 can improve the accuracy of organ evaluation using a medical image.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, configurations, functions, or the like included in each embodiment can be rearranged without logical inconsistency. In addition, configurations or functions included in each embodiment can be used in combination with another embodiment, and multiple configurations or functions can be combined into one, divided, or partially omitted.

For example, an embodiment in which a general-purpose computer functions as the processing server 10 according to the above embodiments can also be implemented. Specifically, a program in which processes for realizing the functions of the processing server 10 according to the above embodiment are written may be stored in a memory of the general-purpose computer, and the program may be read and executed by a processor of the general-purpose computer. Accordingly, the present disclosure can also be implemented as a program executable by a processor, or a non-transitory computer-readable storage medium storing the program. Examples of the non-transitory computer-readable storage medium include a magnetic storage device, an optical disc, a magneto-optical storage device, and a semiconductor memory. A non-transitory computer-readable storage medium storing a program is also referred to as a computer program product.

For example, in the embodiments described above, the processing server 10 is described to perform all of the operations and processing in steps S101 to S105 and steps S201 to S202, the present disclosure is not limited to this configuration. The management server 20 or the user terminal 30 may execute some or all of the operations and processing executed by the processing server 10. In such a case, the management server 20 or the user terminal 30 may be configured to perform some or all of the operations and processing executed by the processing server 10.

### Reference Signs in FIGS

1: Medical image processing system
10: Processing server
11: Communication interface
12: Output interface
13: Input interface
14: Memory
15: Controller
20: Management server
30: User device
40: Network
50: User interface
51: Original image section
52: Highlighted image section
53: Feature quantity section
54: Slider section
55: User input section
56: File upload section
R1, R2, R3, R4: Region

1. A method for processing a medical image performed by a processor, the method comprising:
obtaining a medical image showing an organ;
extracting, from the medical image, at least one target partial image containing an area occupied by the organ with a ratio equal to or greater than a predetermined ratio with respect to a total area of the at least one target partial image;
identifying, in the at least one target partial image, at least one target tissue having a region satisfying a predetermined visual condition;
calculating a feature quantity of the at least one target tissue; and
outputting a processing result including the at least one target partial image and the feature quantity of the at least one target tissue.

2. The method according to claim 1, wherein
the medical image is an image of a specimen collected from the organ.

3. The method according to claim 1, wherein
the extracting the at least one target partial image comprises:
dividing the medical image into a plurality of partial images having a predetermined image size; and
extracting, as the at least one target partial image, at least one partial image containing an area occupied by the organ with a ratio equal to or greater than the predetermined ratio with respect to a total area of the at least one partial image, from among the plurality of partial images.

4. The method according to claim 1, wherein
the identifying the at least one target tissue further comprises identifying, in the at least one target partial image, at least one exclusion region.

5. The method according to claim 1, wherein
the predetermined visual condition comprises a condition regarding at least one of the contour shape, color, or area of the at least one target tissue.

6. The method according to claim 1 further comprising:
building, by machine learning, a calculation model for identifying the region satisfying the predetermined visual condition.

7. The method according to claim 1, wherein
the feature quantity of the at least one target tissue comprises numerical information regarding the area of the at least one target tissue shown in the at least one target partial image.

8. The method according to claim 7, wherein
the calculating the feature quantity of the at least one target tissue comprises:
categorizing the at least one target tissue into at least one first target tissue having an area equal to or greater than a predetermined area or at least one second target tissue having an area less than the predetermined area; and
calculating a feature quantity of the at least one first target tissue and a feature quantity of the at least one second target tissue, and
the predetermined area has a size to be identified by human visual observation with a predetermined accuracy.

9. The method according to claim 1, wherein
the processing result comprises the at least one target partial image in which the at least one target tissue is highlighted according to the feature quantity.

10. The method according to claim 9, wherein
identifying the at least one target tissue comprises identifying, in the at least one target partial image, at least one reference tissue, and
calculating the feature quantity of the at least one target tissue comprises:
determining the predetermined categorization condition based on the at least one reference tissue;
categorizing the at least one target tissue into at least one first target tissue satisfying the predetermined categorization condition or at least one second target tissue not satisfying the predetermined categorization condition; and
calculating a feature quantity of the at least one first target tissue and a feature quantity of the at least one second target tissue.

11. The method according to claim 10, wherein
the predetermined categorization condition is determined based on an area of the at least one reference tissue.

12. The method according to claim 10, wherein
the at least one target tissue is a fat and the at least one reference tissue is a cell nucleus.

13. The method according to claim 10, wherein
the predetermined categorization condition is determined based on a distance between the at least one target tissue and the at least one reference tissue.

14. The method according to claim 13, wherein
the at least one target tissue is a cell nucleus and the at least one reference tissue is a fat.

15. The method according to claim 10, wherein
the feature quantity of the at least one target tissue comprises numerical information regarding an area of the at least one first target tissue shown in the at least one target partial image.

16. The method according to claim 10, wherein
the feature quantity of the at least one target tissue comprises numerical information regarding a number of the at least one first target tissue shown in the at least one target partial image.

17. The method according to claim 10, wherein
the processing result comprises the at least one target partial image in which the at least one first target tissue and the at least one second target tissue are distinctly highlighted.

18. The method according to claim 10 further comprising:
accepting user input for changing the predetermined categorization condition.

19. A system for processing a medical image comprising:
a processor; and
a memory storing a program which, when executed on the processor, causes the processor to perform operations, the operations comprising:
obtaining a medical image showing an organ;
extracting, from the medical image, at least one target partial image containing an area occupied by the organ with a ratio equal to or greater than a predetermined ratio with respect to a total area of the at least one target partial image;
identifying, in the at least one target partial image, at least one target tissue having a region satisfying a predetermined visual condition;
calculating a feature quantity of the at least one target tissue; and
outputting a processing result including the at least one target partial image and the feature quantity of the at least one target tissue.

20. A computer program product for processing a medical image, the computer program product comprising:
a non-transitory computer-readable medium storing a program which, when executed on a processor, causes the processor to execute operations, the operations comprising:
obtaining a medical image showing an organ;
extracting, from the medical image, at least one target partial image containing an area occupied by the organ with a ratio equal to or greater than a predetermined ratio with respect to a total area of the at least one target partial image;
identifying, in the at least one target partial image, at least one target tissue having a region satisfying a predetermined visual condition;
calculating a feature quantity of the at least one target tissue; and
outputting a processing result including the at least one target partial image and the feature quantity of the at least one target tissue.
